(19) United States
(12) Patent Application Publication
(10) Pub. No.: US 2024/0295900 A1
(43) Pub. Date: Sep. 5, 2024

(54) ADJUSTABLE MOUNT

(71) Applicant: Apple Inc., Cupertino, CA (US)

(72) Inventors: Shannon Pomeroy, San Francisco, CA (US); Samuel O. Schneider, Sacramento, CA (US)

(21) Appl. No.: 18/439,104

(22) Filed: Feb. 12, 2024

Related U.S. Application Data
(60) Provisional application No. 63/487,820, filed on Mar. 1, 2023.

(51) Int. Cl. G06F 1/16

(52) U.S. Cl. CPC G06F 1/1607; G06F 1/163

(57) ABSTRACT

A head-wearable apparatus can include a head-mountable display, a head mount positionable onto a human head, a tension adjustment actuator integrated with the head mount, and an arm connectable to the HMD and the head mount. In some examples, the arm includes an HMD tilt adjustment member, and HMD eye relief adjustment member, and an HMD height adjustment member.

### CROSS-REFERENCE TO RELATED APPLICATION(S)

This claims priority to U.S. Provisional Application No. 63/487,820, filed 1 Mar. 2023, and entitled “Adjustable Mount,” the entire disclosure of which is hereby incorporated by reference in its entirety.

### FIELD

The described embodiments relate generally to a head-mountable device. More particularly, the present embodiments relate to an adjustable mount for moving a head-mountable display.

### BACKGROUND

Recent advances in portable computing have enabled head-mountable display (HMD) systems that provide augmented and virtual reality (AR/VR) experiences to users. These HMD systems have many components, such as a display, viewing frame, lens, batteries, and other components. Certain components of the HMD system can also help create a unique user experience. HMD display systems typically include a display, where a user can view and interact with visualizations presented on the display screen of the HMD.

In addition, conventional HMD systems can also be difficult to program, develop, and test new software. Doing so often involves extended durations of wear time and use, which can lend to user discomfort. Exacerbating the extended use durations, users of conventional HMD systems may have differing facial structures that the HMD system cannot accommodate. This user-to-user variation can create a poor user experience, causing pressure on a user's face from the conventional HMD system. Therefore, a head-wearable apparatus capable of a more universal fit and optical performance is desired.

### SUMMARY

An aspect of the present disclosure relates to a head-wearable apparatus. The head-wearable apparatus can include a head-mountable display, a head mount positionable onto a human head, a tension adjustment actuator integrated with the head mount, and an arm connectable to the HMD and the head mount. In some examples, the arm includes an HMD tilt adjustment member, and HMD eye relief adjustment member, and an HMD height adjustment member.

In certain examples, the HMD tilt adjustment member includes: a control, and a curved rack and pinion gear actuatable in response to user input at the control. In some examples, the HMD eye relief adjustment member includes a horizontal rail slidably coupled to the HMD. In particular examples, the HMD height adjustment member includes a vertical rail slidably coupled to the HMD. In at least some examples, the arm further includes an additional HMD tilt adjustment member. Further, in some examples, the head-wearable apparatus includes a donned position where the HMD is spaced apart from contacting the human head. Additionally, in some examples, the head-wearable apparatus includes a removable light seal attached to the HMD. In some examples, the head-wearable apparatus further includes a counterbalance weight attached to the head mount, the counterbalance weight positioned opposite of the HMD.

Another aspect of the present disclosure includes a mounting system for a head-mountable display (HMD). The mounting system can include: an adapter connectable to an HMD and a head mount; and an arm attachable to the adapter. In certain examples, the arm includes: an HMD tilt adjustment member; an HMD eye relief adjustment member; and an HMD height adjustment member.

In one or more examples, the mounting system further includes an HMD, wherein the HMD tilt adjustment member includes an arcuate track along which the HMD is rotatable relative to an optical center. In certain examples, the optical center corresponds to a human eye. In some examples, the arcuate track includes a fixed radius relative to the optical center. In particular examples, at least one of the HMD tilt adjustment member or the HMD height adjustment member is movable to adjust an HMD gaze level specific to user activity or an HMD application. In one or more examples, the mounting system further includes: a mounting bracket attachable to the arm and the HMD; and a sensor positioned in a frame of the HMD adjacent to the mounting bracket. In certain examples, the mounting system further includes a sensor positioned within the mounting bracket.

Yet another aspect of the present disclosure includes a head-wearable apparatus. The head-wearable apparatus can include: a head-mountable display (HMD); an adapter; and an arm removably attached to at least one of the adapter or the HMD. In one or more examples, the arm includes: an arcuate track along which the HMD is rotatable relative to an optical center; and at least three degrees of freedom.

In some examples, the arm includes a vertical adjustment rail and a horizontal adjustment rail; and the adapter includes a mating surface engageable with the arm, the mating surface being parallel to the vertical adjustment rail and perpendicular to the horizontal adjustment rail. In one or more examples, the head-wearable apparatus further includes a removable strap connectable to the HMD, the removable strap being tetherable to at least one of a power supply, a computing device, or an external display. In some examples, the head-wearable apparatus further includes a head mount positionable onto a human head, the head mount including: an adjustable webbing; a tension dial integrated with the adjustable webbing; and a front portion sized and shaped to receive the adapter. In at least one example, the head-wearable apparatus further includes a secondary connection configured to attach the HMD to at least one of the head mount or the adapter.

### BRIEF DESCRIPTION OF THE DRAWINGS

The disclosure will be readily understood by the detailed description below in conjunction with the accompanying drawings, wherein like reference numerals designate like structural elements, and in which:

FIG. 1 shows a top view of an example head-wearable apparatus;

FIG. 2 shows a side view of an example head-wearable apparatus;

FIG. 3 shows another side view of an example head-wearable apparatus;

FIGS. 4-5 respectively show perspective and side views of example portions of a head-wearable apparatus;

FIGS. 6-8 show additional views of other example portions of a head-wearable apparatus;

FIGS. 9A-9C each show front and side schematic views of portions of an example head-wearable apparatus relative to an optical center; and

FIGS. 10A-10C show side schematic views of portions of another example head-wearable apparatus relative to an optical center.

### DETAILED DESCRIPTION

Detailed reference is provided below to representative embodiments illustrated in the accompanying drawings. The following descriptions are not intended to limit the embodiments to one preferred example and are intended to cover alternatives, modifications, and equivalents.

As virtual reality (VR) and mixed reality (MR) become more ubiquitous, the demand for user friendly head-mounted displays with quality components increases. Traditionally, these VR/MR systems have been devices that include a wearable display component, often referred to as a head-mounted display (HMD).

The following disclosure relates to a head-wearable apparatus with improved freedom of HMD mobility, which in turn can lend to improved user experiences and user comfort. For example, a head-wearable apparatus of the present disclosure includes an HMD and a wearable mount (e.g., a halo, wreath, or cap) that comfortably distributes the weight of the HMD across a user's head. Additionally, the wearable mount can be form fitting by way of an adjustment member that can increase or decrease tension (e.g., to comfortably fit different head sizes and head shapes).

Moreover, the head-wearable apparatus of the present disclosure includes a highly configurable arm that connects the HMD and the wearable mount. In at least some examples, this highly configurable arm can provide HMD movement in at least three degrees of freedom. For example, the arm can include an HMD tilt adjustment member that can adjust the HMD in an arcuate fashion. For instance, the HMD tilt adjustment member can adjust an angle of the HMD relative to a user's eye (e.g., while maintaining a fixed gaze radius or eye relief distance from the user's eyes to a central portion of the HMD display of the HMD). Additionally or alternatively, the HMD tilt adjustment member can adjust a combination of eye relief distance and HMD gaze level.

In a particular example, the highly configurable arm of the present disclosure further includes an HMD height adjustment member and an HMD eye relief adjustment member. The height adjustment member can provide vertical (e.g., up-down) movements for the HMD. By contrast, the HMD eye relief adjustment member can provide horizontal (e.g., in-out or forward-backward) movements for the HMD. The foregoing HMD adjustment members can be adjusted on the fly during use and/or upon initial setup. As a result, the HMD adjustment members can flexibly provide a desired optical viewing experience regardless of head size and shape. Additionally, the HMD adjustment members of the present disclosure allow for comfortable transitions to specific user activities or applications (e.g., surfing the internet versus playing a game). Such optical tailoring can therefore reduce user fatigue and enhance user comfort, particularly during extended durations of use or wear.

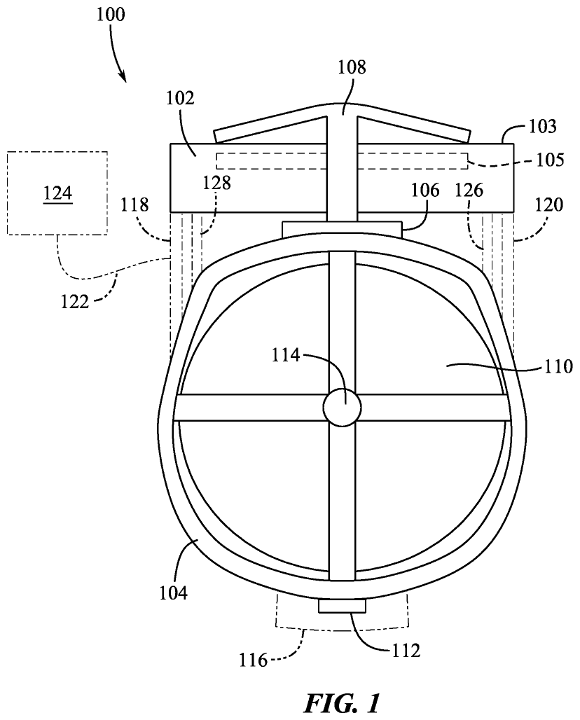

These and other embodiments are discussed below with reference to FIGS. 1-10C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows a top view of a wearable electronic device 100 being worn on a head 110 of a user. The wearable electronic device 100, as well as other wearable electronic devices disclosed herein, can also be referred to as HMD systems, electronic devices, or simply as devices. The device 100 can include a number of modular components. For example, the device 100 can include a head-mounted display (HMD) 102 that includes a housing 103 and a display 105 attached to the housing 103 for displaying images to a user.

The HMD can also be referred to as a display portion or display module having the display 105. The display portion can include the housing 103 and display 105 that at least partially constitutes the HMD. In one or more examples, including the example shown in FIG. 1 and other examples shown in other figures, the HMD 102 can also be referred to as an output component, output module. Such output components, modules, or portions can include one or more outputs other than visual outputs from a display. For example, an output module similar to the HMD 102 can include a speaker that outputs sound instead of or in addition to the display 105 shown in FIG. 1.

In addition, one example of the device 100 can include a head mount 104 that secures the HMD 102 to the user's head 110. As used herein, the term “head mount” refers to a head structure for placing at least partially on or around a user's head. In particular examples, the head mount 104 can be positioned on top of and/or around the user's head 110. That is, the head mount 104 can include a variety of example configurations, such as a halo configuration in which the head mount 104 wraps circumferentially around the user's head 110. In another example, the head mount 104 includes a pillow top configuration in which the head mount 104 at least partially rests upon a top surface of the user's head 110 (e.g., over the crown region of the user head 110). In certain implementations, the head mount 104 at least partially envelops or covers a portion of the user's head 110 (like a baseball hat). Additionally or alternatively, the head mount 104 can contact a specific area or sub-portion of the user's head 110 (like the back of the user's head 110, the sides of the user's head, etc.). Such specific contact areas for the head mount 104 can be achieved using specific mounting configurations, such as a partial band, a semi-circular structure, etc.

In some examples, the head mount 104 can include a webbing that includes one or more adjustable retention bands or securement elements (e.g., ties, cords, fabric loops, cinctures, etc.). Elements of the head mount 104, such as the webbing, can be engaged (e.g., tightened or loosened) via tension adjustment actuator 112, 114. Those of ordinary skill in the art will appreciate that the tension adjustment actuators 112, 114 can be integrated (i.e., implemented) with the webbing of the head mount 104 in a variety of ways.

To illustrate, the tension adjustment actuators 112, 114 can include tension dials (e.g., user-manipulated and/or automated scroll wheels) that wind portions of the webbing. The tension adjustment actuators 112, 114 can actuate (e.g., move) a variety of mechanisms (e.g., worm gears, rack and pinion gears, etc.). Additionally or alternatively, the tension adjustment actuators 112, 114 can include other suitable tension control elements, such as a notch and belt hook. In these or other examples, the head mount 104, including the webbing, is at least partially flexible. In this manner, the head mount 104 can conform to a variety of head shapes and sizes, as well as adjust a desired tightness of fit.

In some examples, the device 100 includes an adapter 106 positioned at a front portion of the head mount 104. The adapter 106 can include a connection element that connects an arm 108 to the head mount 104. To illustrate, the adapter 106 can be removably connected to the head mount 104 (e.g., via fasteners and/or connection ports sized and shaped to receive the adapter 106). In addition, the adapter 106 can include a fitting or joint that is sized and shaped to receive the arm 108. In these or other examples, the adapter 106 can include a plate (e.g., a three-dimensional printed component) sized and shaped to transfer a load from the HMD 102 and the arm 108 to the head mount 104. The adapter 106 can include a variety of materials, including metal, plastic, composites, etc.

The device 100 further includes the arm 108. The arm 108 can include a connection element that connects the HMD 102 to the head mount 104 via the adapter 106. Alternatively, the arm 108 can include a connection element that connects the HMD 102 to the head mount 104 directly (thereby omitting the adapter 106). In these or other examples, this connection can be a removable connection, where the arm 108 can be engaged and disengaged from one or both of the HMD 102 or the adapter 106.

In some examples, the arm 108 is cantilevered from the adapter 106 at one end, and suspends the HMD 102 at the other end of the arm 108. That is, the arm 108 can suspend the HMD 102 relative to an optical center (e.g., the eyes of a user) without contacting the head 110. For instance, the arm 108 can suspend the HMD 102 at a spaced-apart distance of about one millimeter to about eight centimeters horizontally away from the head 110 or an optical center, which distance can constitute an eye relief distance. The arm 108 can also suspend the HMD 102 at different height configurations and angular (e.g., tilt) configurations as will be described below. To do so, the arm 108 can include a variety of adjustment members or movable joints that automatically (or manually) actuate, as will be discussed below in relation to subsequent figures. Indeed, the adjustment members of the arm 108 can provide tremendous flexibility, both in terms of comfort and usability, by allowing the HMD 102 to move in at least three degrees of freedom.

In certain examples, the device 100 includes a counterbalance weight 116. FIG. 1 depicts the counterbalance weight 116 in dashed lines, indicating this element is optional. In particular examples, the counterbalance weight 116 can offset a load from the HMD 102 and the arm 108 cantilevered from the front portion of the head mount 104. Accordingly, the counterbalance weight 116 can be positioned at a backend of the head mount 104 (e.g., in a pocket or other designated holder). In these or other examples, the counterbalance weight 116 is included of a metal element (e.g., lead, tungsten, iron, etc.). In at least some examples, the counterbalance weight 116 is interchangeable for a heavier or lighter weight, as may be desired. Similarly, the counterbalance weight 116 can be removed all together. Further, in at least some examples, the counterbalance weight 116 can be partially or entirely included of an HMD component (rather than added weight), such as power supply connectable to the HMD 102.

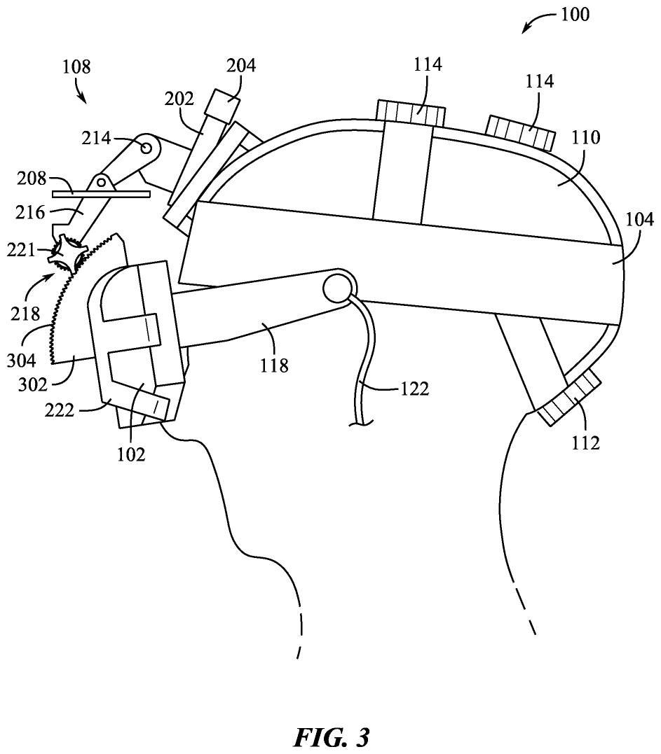

In some examples, the device 100 includes removable straps 118, 120. The removable straps 118, 120 can include a variety of components (e.g., speakers, batteries, memory, processors, etc.). In particular examples, the removable straps 118, 120 removably (i.e., detachably) connect to the HMD 102, but not the head mount 104 (as shown in FIG. 3). In other implementations, the removable straps 118, 120 detachably connect to both the HMD 102 and the head mount 104. For example, each of the removable straps 118, 120 can be removably connected to the HMD 102 (or the housing or the display portion thereof) and the head mount 104 at opposing ends of each removable strap 118, 120. In these or other examples, the removable straps 118, 120 can be connected and detached, as may be desired. For instance, each of the removable straps 118, 120 can be removed and swapped out for one or more other modules, straps, or electronic components.

In certain examples, the removable straps 118, 120 can connect to components external to the device 100. For example, as shown in FIG. 1, the removable strap 118 can optionally connect to a component 124 via a tether 122.

As used herein, the term “tether” can refer to a piece of electrical hardware such as a connection, adapter, dongle, or coupling between an external device/component and one or more components of the device 100 to provide additional functionality, or enable a pass-through to another device that adds functionality. A tether can include electrical connections for data and/or power transmission through the tether. In particular examples, a tether can be uni-directional or bi-directional in terms of data and/or a power transmission.

In some examples, the component 124 can include a power supply. As used herein, the term “power supply” refers to any power source that supplies power to one or more components of the device 100 (e.g., to charge a battery or power a processor such as a microcontroller within the removable strap 118). For example, a power supply can include fuel cells, battery cells, generators, alternators, solar power converters, motion-based converters (e.g., that convert vibrations or oscillations into power), etc. In particular implementations, a power supply can convert alternating current to direct current (or vice-versa) for charging or recharging components of the device 100. Some particular examples of a power supply can include a switched mode power supply, an uninterruptible power supply, an alternating current power supply, a direct current power supply, a regulated power supply, a programmable power supply, a computer power supply, and a linear power supply.

Additionally or alternatively, the component 124 can include an external device or display. An external device can include a smartphone, a tablet, a smart television, a desktop computer, a laptop computer, a server/network device, a virtual reality device, an augmented reality device, a smart watch, a sound/speaker device, a camera device, or other computing device. Further, an external display can include a monitor, device screen (e.g., a display screen for a laptop, television, phone, tablet, etc.), projector, or other suitable visual medium.

In at least some examples, the external device or display includes a developer computer (e.g., for receiving and/or transmitting data from one or more components of the device 100). In particular examples, the external device or display uploads computer-executable instructions to one or more components of the device 100 (e.g., the removable strap 118) through the tether 122. Additionally or alternatively, the external device or display can also provide data to and/or receive data from certain component(s) of the device 100 (e.g., the removable strap 120) through other tether configurations. In some examples, the external device or display receives performance data (e.g., thermal data, power data, data throughput data, etc.).

Additionally or alternatively, the external device or display includes a display that outputs visual information. For example, the external device or display includes a monitor that outputs the same visual content that is shown at the display 105. Thus, advantageously, the external device or display can provide visual feedback (e.g., to developers or programmers) without needing to wear the device 100. Similarly, the external device or display can provide visual feedback (e.g., on a developer computer screen) while a user is simultaneously wearing the device 100.

In some examples, and as shown, the device 100 can be worn on the user's head 110 such that the HMD 102 is positioned in front of the user's face and eyes. The HMD 102 can be removably and/or releasably connected to one or more of the removable straps 118, 120 as mentioned above. In some examples, the removable straps 118, 120 can be positioned against the side of a user's head 110 and in contact therewith. In some examples, the removable straps 118, 120 can be positioned above the user's ear or ears. In some examples, the removable straps 118, 120 can be positioned adjacent to the user's ear or ears (e.g., as a floating strap not in contact with the head 110). In at least some implementations, the removable straps 118, 120 can be removably connected to the head mount 104, which can extend over and/or around the user's head 110 and removably connect to the other of the removable straps 118, 120.

As shown in FIG. 1, the removable straps 118, 120 can connect to the HMD 102, both mechanically and electrically. In particular examples, the removable straps 118, 120 can receive and/or relay at least one of data or power via such connections. In these or other examples, the removable straps 118, 120 can connect to the HMD 102 at an HMD connection location that can include an electrical input or electrical connector that is attached to the housing 103 and electrically connected to the display 105. This location can be identified as a temple area that can be defined as an area near a user's temple adjacent to the user's eye, and can span from in front of the user's eye to approximately 1-1.5 inches past the outer corner of a user's eye, along the side of the user's head 110.

Similarly, the removable straps 118, 120 can optionally connect to the head mount 104 at a connection location identified as an area that can span to include the area above the user's ear or within 0.5 inches of the outer edge of the ear on either side. In this manner, the removable straps 118, 120 are able to provide structural support between the HMD 102 and the user's ear, while also connecting to the head mount 104. It should be understood, however, that this configuration is just one example of how the components of the device 100 can be arranged, and that in some examples, a different number of removable straps can be included.

In the example shown in FIG. 1, when the device 100 is worn on the head of the user, the removable strap 118 is positioned on the left side of the user's head and the removable strap 120 is positioned on the right side of the user's head. However, one or more other examples of the device 100 can include alternative configurations of the removable straps 118, 120 shown in FIG. 1. For example, the removable straps 118, 120 can be positioned elsewhere in relation to the HMD 102 and the head mount 104 (differently than what is shown in FIG. 1). In addition, one or more examples of wearable electronic devices described herein can include one or more intermediate members, flexible straps, or other optional supplemental components and electronic modules such as external power supplies, memory components, and/or processors.

As shown in FIG. 1, the device 100 can optionally include removable light seals 126, 128. It will be appreciated that the term “seal” can include partial seals or inhibitors, in addition to complete seals (e.g., a partial light seal where some ambient light is blocked and a complete light seal where all ambient light is blocked when the device 100 is donned). In these or other examples, the removable light seals 126, 128 can include side wings or inserts that, when attached to at least one of the HMD 102, the adapter 106, or the head mount 104, can block out a user's peripheral vision. Additionally or alternatively, the removable light seals 126, 128 can include a singular light blocker in the form of an attachable (and detachable) mask that can form a facial interface that engages (e.g., conforms to or compresses against) a user face around the user's eyes. In particular, the mask may include a pliant (or semi-pliant) face track that spans the forehead, wraps around the eyes, contacts the zygoma and maxilla regions of the face, and bridges the nose.

These or other examples of the removable light seals 126, 128 can be attached to (and detached from) the device 100 in a variety of ways. For example, the removable light seals 126, 128 can attach via fasteners, interlocking portions, magnets, adhesive strips (e.g., Velcro® strips), etc.

Any of the features, components, parts, including the arrangements and configurations thereof shown in FIG. 1 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 1.

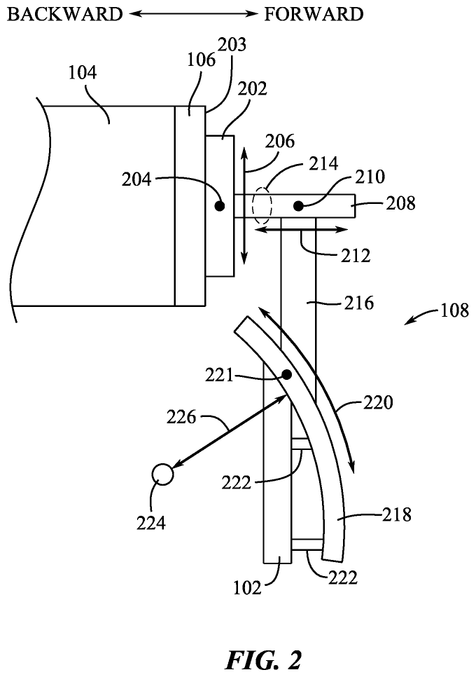

FIG. 2 illustrates a side schematic view of the arm 108 in accordance with one or more examples of the present disclosure. As shown, the arm 108 includes various adjustment members that, when actuated, move the HMD 102 relative to an optical center 224. As used herein, the term “optical center” refers to an optical point of reference. For example, an optical center can include a user's eye, such as a pupil center from which interpupillary distance is commonly determined. In another example, an optical center can include a midpoint between a user's eyes (e.g., at or near a nose bridge).

In these or other examples, the arm 108 can include an HMD height adjustment member 202. As used herein, the terms “HMD height adjustment member” or “display height adjustment member” refer to an arm portion that can move part of the arm 108 up and down in directions 206, thereby providing a first degree of freedom for the HMD 102. Relatedly, the terms “degree of freedom” refer to mobility along a particular plane or axis. Thus, a degree of freedom can include translational movement in various directions (including opposing directions) within a given plane. Similarly, a degree of freedom can include translational movement in opposing directions along a certain axis.

Returning to the HMD height adjustment member 202, as the HMD height adjustment member 202 is adjusted up or down in the directions 206, an HMD gaze level is correspondingly adjusted. The HMD gaze level includes a distance measure of how high or low the optical center 224 is positioned relative to the HMD 102 (e.g., a center of the display portion of the HMD 102). In these or other examples, the HMD height adjustment member 202 can include a vertical rail along which the HMD height adjustment member 202 can slide or otherwise engage (e.g., in a geared engagement) upwards or downwards in the directions 206 relative to the adapter 106. The vertical rail can be positioned on a mating surface 203 of the adapter 106. The mating surface 203 is oriented vertically and outwardly (i.e., in a forward direction) to engage the HMD height adjustment member 202. In a slidably coupled configuration, components can at least partially release from one another to allow one or both components to slide or translate adjacent to one another (e.g., along some linear or non-linear path). Alternatively, the HMD height adjustment member 202 itself is positionally fixed but, when actuated, causes the connecting component (in this case, the HMD eye relief member 208) to correspondingly move up or down along the directions 206 relative to the adapter 106 and the HMD height adjustment member 202.

In particular examples, the HMD height adjustment member 202 includes a control 204 that, when actuated, causes the HMD height adjustment member 202 to move up or down along the directions 206 relative to the adapter 106. Examples of the control 204 can include a button, knob, scroll, lever, or other user-interactive element. Alternatively, the control 204 can be automated (e.g., in response to computer-executed instructions, eye gestures, voice commands, etc.). To illustrate, eye tracking sensors within the HMD 102 can transmit a signal, based on eye movement that causes the control 204 to actuate and move the HMD height adjustment member 202.

The arm 108 can further include an HMD eye relief adjustment member 208. As used herein, the terms “HMD eye relief adjustment member” or “display eye relief adjustment member” refer to an arm portion that can move part of the arm 108 forward and backward in directions 212, thereby providing another degree of freedom for the HMD 102. Specifically, as the HMD eye relief adjustment member 208 is adjusted forward and backward in the directions 212, an eye relief distance is correspondingly adjusted. The eye relief distance includes a distance measure of how far away the optical center 224 is positioned relative to the HMD 102 (e.g., a center of the display portion of the HMD 102). In these or other examples, the HMD eye relief adjustment member 208 can include a horizontal rail along which the HMD eye relief adjustment member 208 can slide or otherwise engage (e.g., in a geared engagement) forwards and backwards in the directions 212 relative to the adapter 106 or the HMD height adjustment member 202. Alternatively, the HMD eye relief adjustment member 208 itself is positionally fixed but, when actuated, causes the connecting component (in this case, a connection element 216) to correspondingly move forwards or backwards along the directions 212 relative to the adapter 106 and the HMD eye relief adjustment member 208.

In particular examples, the HMD eye relief adjustment member 208 includes a control 210 that, when actuated, causes the HMD eye relief adjustment member 208 to move forwards or backwards along the directions 212 relative to the adapter 106. Examples of the control 210 can include a button, knob, scroll, lever, or other user-interactive element. Alternatively, the control 210 can be automated (e.g., in response to computer-executed instructions, eye gestures, voice commands, etc.). To illustrate, eye tracking sensors within the HMD 102 can transmit a signal, based on eye movement that causes the control 210 to actuate and move the HMD eye relief adjustment member 208.

It will be appreciated that the terms “horizontal” and “vertical” can mean true horizontal and true vertical relative to a ground surface or gravity's pull. However, these terms are not so limited and can instead be relative. Indeed, the term horizontal can refer to a perpendicular (or near perpendicular) relationship of a component relative to an upright component within an HMD system or relative to a facial plane (or other bodily reference plane). By contrast, the term vertical can refer to a parallel (or near parallel) relationship of a component relative to an upright component within an HMD system or relative to a facial plane (or other bodily reference plane). Moreover, the terms horizontal and vertical can be dependent upon a position of the HMD system or even the arm 108 itself.

The arm 108 can further include an HMD tilt adjustment member 218. As used herein, the terms “HMD tilt adjustment member” or “display tilt adjustment member” refer to an arm portion that can move part of the arm 108 along an arcuate path in directions 220, thereby providing yet another degree of freedom for the HMD 102. The HMD tilt adjustment member 218 is connected to the HMD 102 via a mounting bracket 222 (and associated fasteners, not shown). Thus, as the HMD tilt adjustment member 218 is adjusted along an arcuate path in the directions 220, the HMD 102 moves as well. In particular, a combination of eye relief distance and HMD gaze level (both discussed above) is correspondingly adjusted.

In these or other examples, the HMD tilt adjustment member 218 can include an arcuate track along which the HMD tilt adjustment member 218 can slide or otherwise engage (e.g., in a geared engagement) along an arc track in the directions 220 relative to the optical center 224. The term “arcuate” should be interpreted as non-linear or curved. In particular examples, the HMD tilt adjustment member 218 is positioned along a radius 226 relative to the optical center 224. In certain examples, the radius 226 includes a fixed radius relative to the optical center 224. In this manner, the arcuate track can maintain a constant distance from the optical center 224. Moreover, as the HMD tilt adjustment member 218 is rotated in an angular fashion along the directions 220, the display portion of the HMD 102 is adjusted in terms of height and eye relief distance relative to the optical center 224.

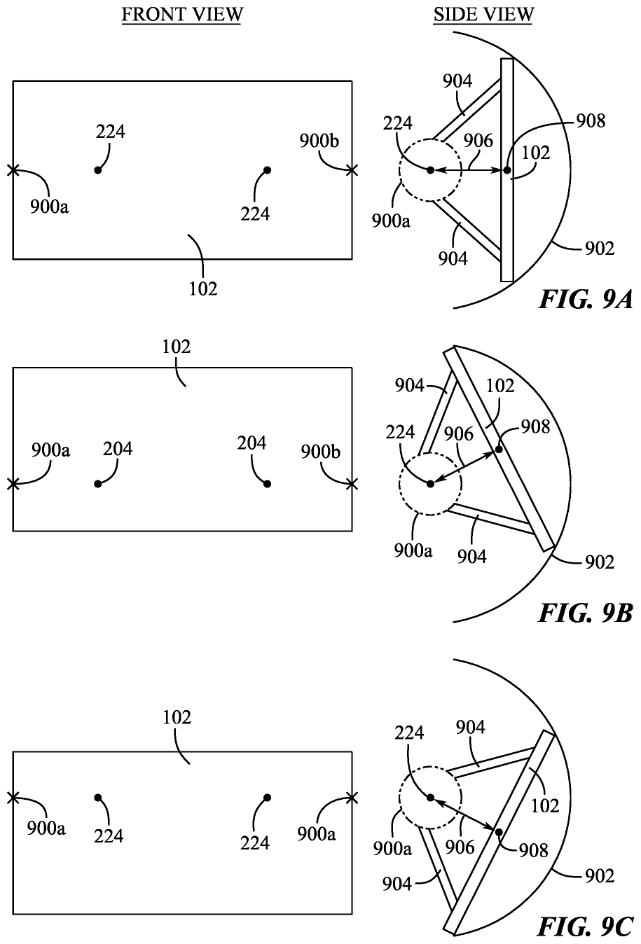

It will be appreciated that, in at least some examples, the radius 226 can correspond to a different measurement from the optical center 224. For example, the radius 226 can include a distance measurement from the optical center 224 to a central portion of the HMD display (i.e., the display 105 in FIG. 1 rather than the arcuate track of the HMD tilt adjustment member 218). Further, in some examples, the HMD tilt adjustment member 218 can maintain a constant gaze radius from the optical center 224 to a central portion of the HMD display of the HMD 102. To do so, the HMD tilt adjustment member 218 can be arcuately shaped (and correspondingly connected to the HMD 102) such that a travel path of the HMD 102 corresponds to a constant gaze radius between the optical center 224 and a central portion of the HMD display of the HMD 102. Such an example of a fixed gaze radius is described more below in relation to FIGS. 9A-9C.

In particular examples, the HMD tilt adjustment member 218 includes a control 221 that, when actuated, causes the HMD tilt adjustment member 218 to move along the arcuate track of the HMD tilt adjustment member in the directions 220 relative to optical center 224. Examples of the control 221 can include a button, knob, scroll, lever, or other user-interactive element. Alternatively, the control 221 can be automated (e.g., in response to computer-executed instructions, eye gestures, voice commands, etc.). To illustrate, eye tracking sensors within the HMD 102 can transmit a signal, based on eye movement that causes the control 221 to actuate and move the HMD tilt adjustment member 218.

Further shown in FIG. 2, the arm 108 can include an additional HMD tilt adjustment member 214. In some examples, the additional HMD tilt adjustment member 214 can include a revolute joint. The revolute joint can allow a portion of the arm 108 to rotate (e.g., in large-scale rotation movements). For example, a portion of the arm 108 forward of the revolute joint can rotate clockwise and counterclockwise as may be desired. To illustrate, the portion of the arm 108 forward of the revolute joint can rotate from a viewable display position (as illustrated) to visual-navigation position by rotating counterclockwise between 15 and 120 degrees. In doing so, the HMD 102 and connecting portions are at least partially flipped up (i.e., removed from in front of the optical center 224), thereby providing a more open view less obstructed by the HMD 102. Such a use case may be helpful for visually navigating an ambient environment with the head wearable apparatus still donned on the user's head. In yet another example use case, the additional HMD tilt adjustment member 214 can provide large scale rotations comparatively quicker than the HMD tilt adjustment member 218; whereas the HMD tilt adjustment member 218 can provide finer rotational resolution (as may be desired).

Any of the features, components, parts, including the arrangements and configurations thereof shown in FIG. 2 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 2.

FIG. 3 illustrates an example of the head-wearable apparatus 100 in accordance with one or more examples of the present disclosure. As shown, the head-wearable apparatus 100 is located in a donned positioned on top of the user's head 110. As used herein, a “donned position” refers to a worn position in which the head mount 104 is positioned on top of or around a user's head 110. In the donned position, the user's face can be spaced apart from and out of contact with the HMD 102. For example, the head-wearable apparatus 100 in the donned position can include the HMD 102 positioned in front of an optical center 224 (not shown). As another example, the head-wearable apparatus 100 in the donned position includes the head mount 104 atop a user's head 110, but the HMD 102 flipped up (e.g., via the additional HMD tilt adjustment member 214) away from the optical center 224.

FIG. 3 further shows example components of the arm 108, discussed above. In particular, the HMD tilt adjustment member 218 includes an arcuate track 302 with a geared engagement surface 304. In these or other examples, the control 221 includes a pinion gear, while the arcuate track 302 and the geared engagement surface 304 make up a curved rack. Together, the pinion gear can cause the curved rack to rotationally move. Specifically, as the control 221 is actuated, a corresponding geared engagement surface of the control 221 can contact and engage the geared engagement surface 304. In turn, the geared engagement surface 304 and the arcuate track 302 are rotated about an optical center (e.g., the optical center 224, not shown). By virtue of this rotation, the HMD 102 is correspondingly rotated.

In some examples, at least one of the HMD height adjustment member 202, the HMD eye relief adjustment member 208, or the HMD tilt adjustment member 218 can be adjusted in response to actuation of corresponding controls (whether automated or manual). Such an adjustment or actuation can be specific to certain use cases. For example, a gaze level can be adjusted via at least one of the HMD height adjustment member 202, the HMD eye relief adjustment member 208, or the HMD tilt adjustment member 218 based on a particular user activity. To illustrate, a user activity can include physical acts performed by a user (sitting, standing, walking, jumping, exercising, etc.). User activity can also include a location or ambient environment of a user during operation or wearing of the head-wearable apparatus 100. For instance, a user activity can include being outdoors, being indoors, being in low-light conditions, being in bright-light conditions, etc. As a specific example, at least one of the HMD height adjustment member 202, the HMD eye relief adjustment member 208, or the HMD tilt adjustment member 218 can be adjusted in response to a user sitting down onto a couch while wearing the head-wearable apparatus 100 (e.g., to account for a user's accustomed gaze level being slightly upwards towards a television or display screen).

In yet another example, a gaze level can be adjusted via at least one of the HMD height adjustment member 202, the HMD eye relief adjustment member 208, or the HMD tilt adjustment member 218 based on a particular HMD application executed by the head-wearable apparatus at the HMD 102. An HMD application can include computer-executable instructions for generating a visual image or a series of images (with or without sound, haptics, etc.) at the HMD 102. In particular examples, an HMD application can include a game, puzzle, virtual interaction, or virtual experience. As a specific example, at least one of the HMD height adjustment member 202, the HMD eye relief adjustment member 208, or the HMD tilt adjustment member 218 can be adjusted in response to a user initiating a bird watching application at the HMD 102. In this case, the HMD 102 can be adjusted to account for a user's accustomed gaze level being upwards towards tree branches and tall foliage.

Any of the features, components, parts, including the arrangements and configurations thereof shown in FIG. 3 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 3.

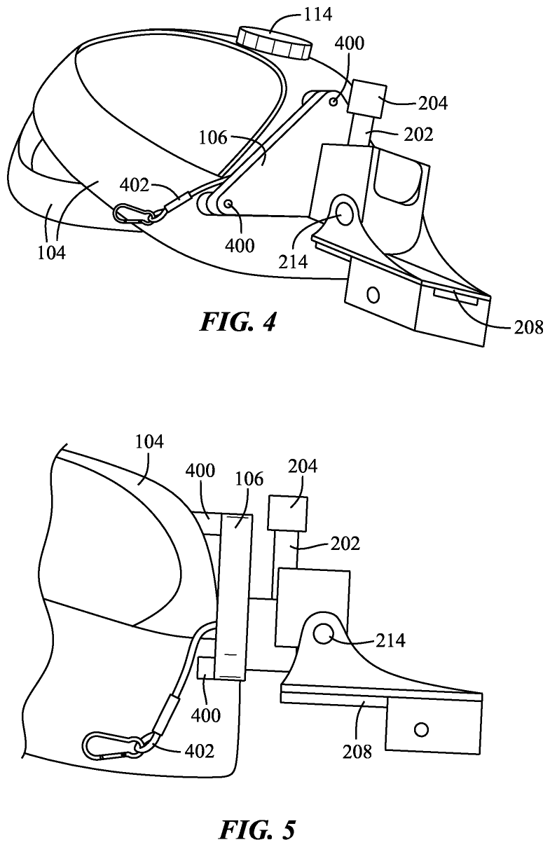

FIGS. 4-5 illustrate another example of a portion of the head-wearable apparatus 100 in accordance with one or more examples of the present disclosure. In particular, FIGS. 4-5 illustrate a perspective view and a side view, respectively, of an example of the head-wearable apparatus 100 without the HMD tilt adjustment member 218 and the HMD 102. In particular, FIGS. 4-5 depict many of the same or similar features described above.

In addition, FIGS. 4-5 illustrate connectors 400. In some examples, the connectors 400 include fasteners (e.g., bolts, screws, etc.) that removably couple the adapter 106 to the head mount 104. In certain implementations, the connectors 400 can include vibrational dampeners or gaskets to provide a cushioned mounting between the adapter 106 and the head mount 104. Additionally or alternatively to the connectors 400, the adapter 106 can be mounted to the head mount 104 in a variety of ways. For instance, the adapter 106 can interlock with or releasably clamp onto the head mount 104. In other implementations, the adapter 106 can be adhered to the head mount 104.

Further shown, in one or more examples, the head-wearable apparatus 100 can include a secondary connection 402. In certain examples, the secondary connection 402 includes a secondary mount or attachment to the HMD 102 independent of the arm 108. In specific implementations, the secondary connection 402 is positioned between the head mount 104 and the adapter 106. Additionally or alternatively, the secondary connection 402 is at least partially routed through the head mount 104. In this manner, the secondary connection 402 can secure the HMD 102 to at least one of the head mount 104 or the adapter 106 in the event of failure or incident to the arm 108. Accordingly, the secondary connection 402 can include a variety of different attachment members. For instance, the secondary connection 402 can include ties, cords, carabiners, hooks, loops, etc. In other instances, the secondary connection 402 can include connectors, ports, or other mounting member sized and shaped to receive a corresponding connector on the HMD 102.

Any of the features, components, parts, including the arrangements and configurations thereof shown in FIGS. 4-5 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIGS. 4-5.

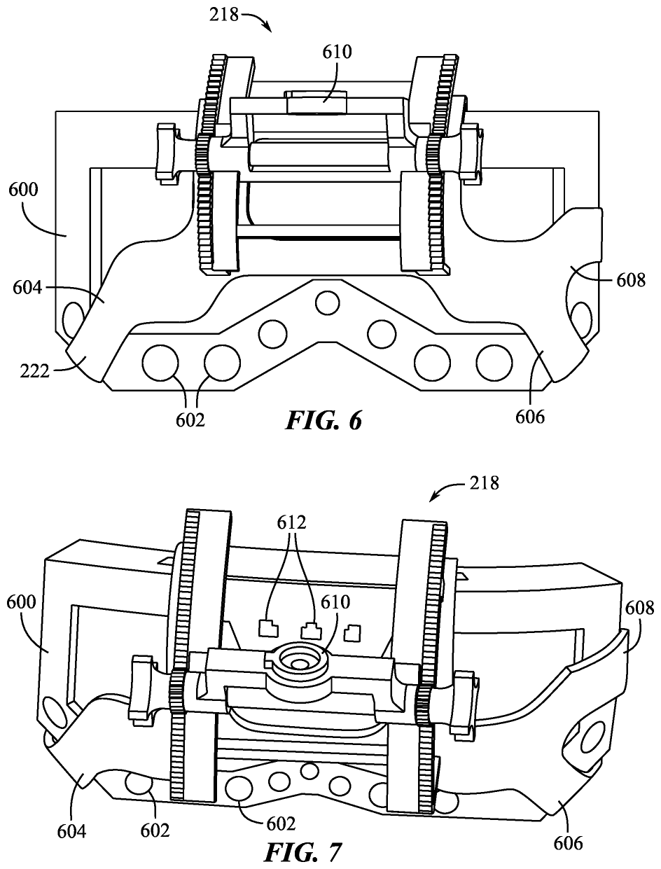

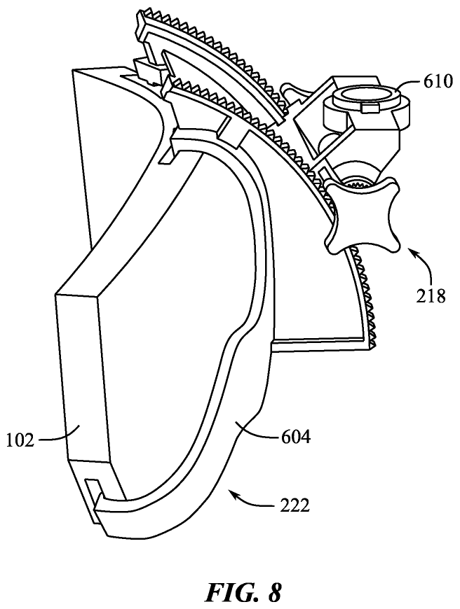

FIGS. 6-8 illustrate example portions of a head-wearable apparatus 100 in accordance with one or more examples of the present disclosure. In particular, FIGS. 6-7 illustrate the HMD 102 without a frame cover. By contrast, FIG. 8 illustrates the HMD 102 with a frame cover (e.g., a glass frame cover) in place. Thus, FIGS. 6-7 depict the HMD 102 as including an HMD frame 600 (which is the same as or similar to the housing 103 of FIG. 1).

As shown, HMD frame 600 includes an outer rim or shell that structurally defines the HMD 102. In particular, the HMD frame 600 defines sensor cutouts 602 positioned along a lower portion of the HMD frame 600. It will be appreciated, however, that the HMD frame 600 can define the sensor cutouts 602 in other portions of the HMD frame 600 in addition to (or in the alternative to) the lower portion of the HMD frame 600.

In these or other examples, the sensor cutouts 602 are sized and shaped to receive one or more of a variety of sensors. As used herein, the term “sensor” refers to one or more different sensing devices, such as a camera or imaging device, temperature device, oxygen device, movement device, brain activity device, sweat gland activity device, breathing activity device, muscle contraction device, etc. A particular example of sensors include a camera for pass-through imaging (e.g., to depict a visualization of an ambient environment via the camera). Another example of sensors includes ambient light sensors (e.g., to sense lighting conditions around the head-wearable apparatus 100). Other examples of sensors include an electrooculography sensor, electrocardiography sensor, EKG sensor, hear rate variability sensor, blood volume pulse sensor, SpO2 sensor, compact pressure sensor, electromyography sensor, core-body temperature sensor, galvanic skin sensor, accelerometer, gyroscope, magnetometer, inclinometer, barometer, infrared sensor, global positioning system sensor, inertial measurement unit, etc.

Additionally shown, the HMD frame 600 defines the sensor cutouts 602 positioned adjacent to (e.g., next to, around, or within proximity of) the mounting bracket 222, which connects the HMD tilt adjustment member 218 and the HMD 102 as mentioned above. The mounting bracket 222 can have a variety of configurations within the scope of the present disclosure. However, as depicted, the mounting bracket 222 includes a mounting bracket limb 604, mounting bracket limb 606, and a mounting bracket limb 608. Therefore, in this case, the sensor cutouts 602 are positioned on one or more sides of the mounting bracket limbs 604-608. By being positioned adjacent to the mounting bracket 222 (i.e., by positionally circumventing the mounting bracket limbs 604-608), sensors positioned within the sensor cutouts 602 can maintain an unobstructed (or at least a less limited) field of view. As used herein, the term “field of view” for a sensor corresponds to a range of detectability and/or a spatial orientation for sensing (e.g., a certain distance of sensor range, a certain angular window of sensor range, etc.). In some examples, a field of view can also include a shaped field in which data can be sensed (e.g., a cone-shaped field of view).

Similarly, the sensor cutouts 602 and/or other sensor cutouts can be positioned or arranged around the HMD tilt adjustment member 218. For example, the HMD frame 600 can define sensor cutouts 612 positioned along an upper portion of the HMD frame 600 in between arcuate tracks of the HMD tilt adjustment member 218. In such an example position, ambient light sensors can be embedded within the sensor cutouts 612 to identify an amount of ambient light for the head-wearable apparatus 100.

In at least some examples, sensors can also be positioned on or within the mounting bracket limbs 604-608. To illustrate, and inertial measurement unit can be positioned within at least one of the mounting bracket limb 604, 606. In addition, another inertial measurement unit can be positioned within the mounting bracket limb 608. Using multiple datum references in this manner, the head-wearable apparatus 100 can determine various adjustments to the HMD 102, including height adjustments, eye relief adjustments, and tilt adjustments.

Further shown in FIGS. 6-8, the HMD tilt adjustment member 218 includes a connector port 610. The connector port 610 is sized and shaped to receive the connection element 216 and the remainder portion of the arm 108 discussed above.

Any of the features, components, parts, including the arrangements and configurations thereof shown in FIGS. 6-8 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIGS. 6-8.

FIGS. 9A-9C each show front and side schematic views of portions of an example head-wearable apparatus relative to an optical center in accordance with one or more examples of the present disclosure. In particular, each of FIGS. 9A-9C illustrate front and side views of the HMD 102 in unadjusted, raised, and lowered positions, respectively. It will be appreciated, however, that the HMD 102 can rotate to other positions than illustrated, as may be desired.

In these examples, the HMD 102 is connected to revolute joints 900a, 900b via connectors 904. The revolute joints 900a, 900b can be positioned in a temple area or otherwise adjacent to a user's head. In some examples, the revolute joints 900a, 900b allow the HMD 102 to pivot up and down in a horseshoe path. For instance, the HMD 102 can pivot such that top and bottom edges of the HMD 102 follow an arc 902. Moreover, the HMD 102 in these examples can pivot relative to the optical centers 224. Specifically, the HMD 102 can rotate about the optical centers 224 in a manner that maintains a fixed gaze radius 906, which is a constant distance from the optical centers 224 to a display center 908 of the HMD 102. By maintaining the fixed gaze radius 906, regardless of HMD positioning, a user can maintain a desired user experience (or user settings).

Any of the features, components, parts, including the arrangements and configurations thereof shown in FIGS. 9A-9C can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIGS. 9A-9C.

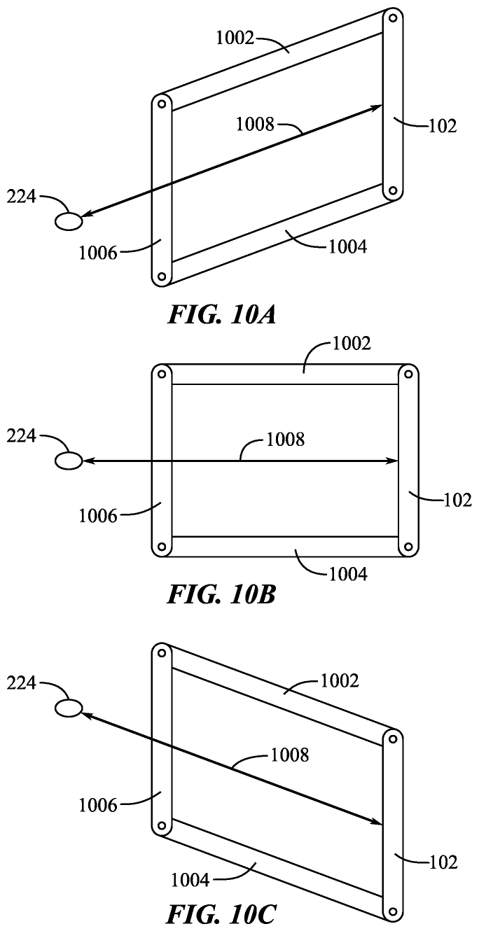

FIGS. 10A-10C show side schematic views of portions of another example head-wearable apparatus relative to an optical center in accordance with one or more examples of the present disclosure. As shown, the HMD 102 in this example can move relative to the optical center 224 via a 4-bar linkage. As used herein, the term “4-bar linkage” refers to a structure with four elements joined together. For instance, in some examples, the 4-bar linkage of the present disclosure includes a fixed anchor structure, rotatable pivot arms, and a pivotable display (i.e., the HMD 102). In other examples, a 4-bar linkage includes a structure with four linkages (e.g., connecting arms) that can rotate or pivot relative to joined components. For instance, as shown in FIGS. 10A-10C, the 4-bar linkage can include a top arm 1002, a bottom arm 1004, an anchor structure 1006, and the HMD 102—all coupled together via rotational pivot points. Being a side view, it will be appreciated that there can be a pair of top arms and a pair of bottom arms that link the anchor structure 1006 and the HMD 102. That is, only the top arm 1002 and the bottom arm 1004 of one side are visible in the side views of FIGS. 10A-10C.

The anchor structure 1006 can be attached to a head mount discussed above (e.g., by suspending the anchor structure 1006 from the head mount). In these or other examples, the anchor structure can maintain a fixed position relative to the optical center 224.

By contrast, the top arm 1002 and the bottom arm 1004 can pivot up and down. In so doing, the HMD 102 can correspondingly move up and down to provide the desired view (or viewing angle) relative to the optical center 224. For instance, as shown in FIG. 10A, the top arm 1002 and the bottom arm 1004 are rotated upwards to correspondingly move the HMD 102 upwards relative to the optical center 224. Then, as shown in FIG. 10B, the top arm 1002 and the bottom arm 1004 are leveled (e.g., horizontally) to correspondingly center the HMD 102 in front of the optical center 224. Additionally, as shown in FIG. 10C, the top arm 1002 and the bottom arm 1004 are rotated downwards to correspondingly move the HMD 102 lower relative to the HMD 102.

In these or other examples, the HMD 102 includes a gaze radius 1008 relative to the optical center 224. Measured from the optical center 224 to the center of the HMD 102, the gaze radius 1008 can change as the HMD 102 rotates up and down with the top arm 1002 and the bottom arm 1004. However, the distance from the optical center 224 to the viewing plane (i.e., the vertical plane of motion for the HMD 102) remains constant. The distance from the optical center 224 to the viewing plane remains constant because the anchor structure 1006 is positionally fixed and because the lengths of the top arm 1002 and the bottom arm 1004 are fixed lengths.

It will be appreciated that the 4-bar linkage illustrated in the present examples can be modified for use with an HMD system. For instance, motion of at least one of the pivot arms 1002-1004 can be limited such that the pivot arm(s) (and associated ranges of motion) fit within a housing or frame of the HMD 102. Further, as with other adjustments described herein, such adjustments can be automated or manual, as may be desired. For instance, a servo motor can be implemented to automatically adjust the angles of the top arm 1002 and/or the bottom arm 1004 to correspondingly adjust the HMD 102.

Any of the features, components, parts, including the arrangements and configurations thereof shown in FIGS. 10A-10C can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIGS. 10A-10C.

In some examples, the system can use user specific information to provide a customized experience. Whenever personal user specific information is used, its collection, storage, use, and access should be performed in accordance with well-established and accepted protocols and procedures.

For purposes of explanation, the description above included a number of examples. However, the specific details are not required in order to practice the described embodiments and are presented for purposes of illustration and description only. Rather, many modifications and variations are possible in view of the above teachings.

What is claimed is:

1. A head-wearable apparatus, comprising:
a display;
a head mount positionable on a human head;
a tension adjustment actuator integrated with the head mount; and
an arm connectable to the display and the head mount, the arm comprising:
a display tilt adjustment member;
a display eye relief adjustment member; and
a display height adjustment member.

2. The head-wearable apparatus of claim 1, wherein the display tilt adjustment member comprises:
a control;
a curved rack; and
a pinion gear connected to the curved rack, the pinion gear actuatable in response to a user input at the control.

3. The head-wearable apparatus of claim 1, wherein the display eye relief adjustment member comprises a horizontal rail slidably coupled to the display.

4. The head-wearable apparatus of claim 1, wherein the display height adjustment member comprises a vertical rail slidably coupled to the display.

5. The head-wearable apparatus of claim 1, wherein:
the display tilt adjustment member comprises a first display tilt adjustment member; and
the arm further comprises a second display tilt adjustment member.

6. The head-wearable apparatus of claim 1, wherein the display is spaced apart from the human head when donned.

7. The head-wearable apparatus of claim 1, further comprising a removable light seal attached to the display.

8. The head-wearable apparatus of claim 1, further comprising a counterbalance weight attached to the head mount opposite the display.

9. A mounting system for a head-mountable display (HMD), the mounting system comprising:
an adapter connectable to the HMD and a head mount; and
an arm attachable to the adapter, the arm comprising:
an HMD tilt adjustment member;
an HMD eye relief adjustment member; and
an HMD height adjustment member.

10. The mounting system of claim 9, wherein the HMD tilt adjustment member comprises an arcuate track along which the HMD is rotatable relative to an optical center.

11. The mounting system of claim 10, wherein the optical center corresponds to a human eye.

12. The mounting system of claim 10, wherein the arcuate track comprises a fixed radius relative to the optical center.

13. The mounting system of claim 9, wherein at least one of the HMD tilt adjustment member or the HMD height adjustment member is movable to adjust an HMD gaze level based on an HMD application.

14. The mounting system of claim 9, further comprising:
a mounting bracket attachable to the arm and the HMD; and
a sensor positioned in a frame of the HMD adjacent to the mounting bracket.

15. The mounting system of claim 14, further comprising a sensor positioned within the mounting bracket.

16. A head-wearable apparatus, comprising:
a display;
an adapter; and
an arm removably attached to at least one of the adapter or the display, the arm comprising:
an arcuate track along which the display is rotatable relative to an optical center; and
at least three degrees of freedom.

17. The head-wearable apparatus of claim 16, wherein:
the arm comprises a vertical adjustment rail and a horizontal adjustment rail; and
the adapter comprises a mating surface engageable with the arm, the mating surface being parallel to the vertical adjustment rail and perpendicular to the horizontal adjustment rail.

18. The head-wearable apparatus of claim 16, further comprising a removable strap connectable to the display, the removable strap being tetherable to at least one of a power supply, a computing device, or an external display.

19. The head-wearable apparatus of claim 16, further comprising a head mount positionable onto a human head, the head mount comprising:
an adjustable webbing;
a tension dial integrated with the adjustable webbing; and
a front portion sized and shaped to receive the adapter.

20. The head-wearable apparatus of claim 19, further comprising a secondary connection configured to attach the display to at least one of the head mount or the adapter.
